(19) United States
(12) Patent Application Publication
(10) Pub. No.: US 2008/0280253 A1
(43) Pub. Date: Nov. 13, 2008

(54) Method for Receiving a Medical Element in a Manipulation Apparatus, a Manipulation Apparatus, for a Medical Element and Implant

(75) Inventors: Michael Augthun, Mulheim (DE); Thomas Boschemeyer, Herdecke (DE); Volkhard-Hagen Clostermann, Hagen (DE); Nico Dragotto, Lunen (DE); Klaus Haselhuhn, Aachen (DE); Manfred Peters, Wolfenbuttel (DE); Hubertus Spiekermann, Haan (DE); Karl-Wilhelm Theis, Leichlingen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Heraeus Kulzer GmbH, Hanau (DE)

(21) Appl. No.: 11/917,322

(22) PCT Filed: Jun. 13, 2006
(86) PCT No.: PCT/EP2006/006392

§ 371 Date: Jul. 14, 2008

(30) Foreign Application Priority Data
Jun. 13, 2005 (DE) 10 2005 027 400.5

(51) Int. Cl. A61C 3/00

(52) U.S. Cl. 433/141

(57) ABSTRACT

A method is disclosed for receiving a medical element in a manipulation apparatus in such a way that it can be inserted in an implant or be removed therefrom and the medical element is secured against longitudinal displacement by means of clip element, whereby a security element is introduced into the clip element such that the clip element is spread or blocked perpendicular to the longitudinal axis.

The invention relates at first to a method for receiving a medical element in a manipulation apparatus, with the medical element being received by means of a receiving element in such a way that it can be inserted in an implant by means of a manipulation apparatus having the receiving element or can be removed from the implant, with the receiving element being introduced into the receiving recess in a longitudinal direction of a receiving recess of the medical element and being secured in the receiving recess by means of a clip element against displacement in the longitudinal direction. The invention further relates to a manipulation apparatus for a medical element, comprising a receiving element by means of which the medical element can be received for insertion into an implant or for removal from the implant, with the receiving element being introducible into a receiving recess of the medical element in a longitudinal direction of the receiving recess and being securable by means of a clip element against displacement in the longitudinal direction, and finally to an implant which can be implanted in a bone by screwing into a receiving bore.

Within the scope of generally known implant systems in the dental area, medical elements such as substitute teeth, healing caps, impression posts or gingival former are not held directly by hand by the surgeon and by the dental technician in the lab, but are received by specially adjusted manipulation apparatuses. It is known especially in this respect to receive the medical elements by means of a pincer-like receiving element which is arranged on the manipulation apparatus. The receiving element engages for this purpose into recesses or grooves provided circumferentially on the side of the medical element. The medical element is secured against inadvertent detachment from the manipulation apparatus in such a way that the opening of the pincer-like receiving element is blocked.

For the implantation, a sleeve-like implant with a simple cover or healing cap is inserted at first into the bone. As soon as this implant, which at first is without function and is therefore not loaded mechanically, has healed in and is rigidly connected with the bone, the healing cap can be removed by means of the manipulation apparatus and any desired medical element can be inserted instead. Individual missing natural teeth can be replaced by artificial, but fixed substitute teeth. Such implant systems are also suitable for closing larger gaps in teeth with several natural teeth missing side by side or for restructuring a completely new set of teeth without any remaining natural teeth.

When removing a healing cap from an implanted implant that has healed into the jawbone, the gums enclosing the implant should be damaged as little as possible. Moreover, in the dental field the implant often only has a small distance to the adjacent teeth (or implants) for medical reasons. The space available for handling the manipulation apparatus is thus usually very tight.

A method and a manipulation apparatus of the kind mentioned above is disclosed for example by U.S. Pat. No. 6,644,969 B2. The application of the proposed implant system is improved over the previous use of receiving elements attacking on the side in a pincer-like way in such a way that a receiving element arranged as a clip receiving element engages in a receiving recess of a healing cap provided for this purpose.

In this known implant system, the healing cap is also snapped into the implant, with the clipping force which holds the healing cap in the implant being larger than the clipping force which holds the receiving element of the manipulation apparatus used for the insertion in the receiving recess of the healing cap. After the insertion of the healing cap the manipulation apparatus can be removed from the same, with the healing cap remaining in the implant. In order to remove the healing cap from the implant again, a second receiving element which is formed on the same manipulation apparatus is introduced into the receiving recess whose clipping force is higher than the one in the healing cap in the implant.

### OBJECT OF THE INVENTION

The invention is based on the object of simplifying manipulation of the medical element.

### Solution

Based on the known methods, it is proposed at first in accordance with the invention that a securing element is introduced in the longitudinal direction into the clip element in such a way that the clip element is spread open and/or blocked perpendicular to the longitudinal direction. On the one hand, such a pin-like securing element can fix a wing of a clipped connection in the “clipped-in” position, which wing is held in an articulated manner (i.e. load-free) on the manipulation apparatus. On the other hand, the combination with a resilient wing is also useful which in its initial position is deflected radially to the inside, i.e. it is “clipped out”. The clip element is then simultaneously “clipped in” and secured in the holding position only by insertion of the securing element. When the securing element is removed again, the clip element is simultaneously “clipped out” of the holding position and the medical element can be detached from the implant without any resistance.

As compared with the known methods, it is not necessary to manipulate in the environment but only above the medical element when receiving the medical element according to the method in accordance with the invention by means of the manipulation apparatus. Manipulation of the medical element is thus made significantly more easy, especially in environments of restricted space. Even when implanting directly adjacent to a tooth or an adjacent implant, the insertion or removal of a medical element does not pose any major problem.

Based on the known manipulation apparatuses it is thus proposed that a securing element can be introduced into the clip element in the longitudinal direction in such a way that the clip element is spread out and/or blocked perpendicular to the longitudinal direction. In combination with a respective medical element, such a manipulation apparatus in accordance with the invention allows carrying out the method in accordance with the invention.

A manipulation apparatus in accordance with the invention especially preferably comprises a clip element which is arranged on the receiving element and which comprises at least one wing movable transversally to the longitudinal direction which can be brought into engagement in a non-positive manner with an inner jacket surface of the receiving recess. Clip elements, which are elements that clip into a fitting receiving recess upon insertion and offer a defined resistance to releasing the connection, represent a possibility of connecting a manipulation apparatus with the medical element which can be manipulated in an especially simple way.

Preferably, the movable wing of the clip element is resiliently connected with the receiving element of the manipulation apparatus in accordance with the invention. The movable wing has a defined position in the non-tensioned initial position and can be brought to the tensioned state by exerting a similarly defined force. The initial position can especially be the position in which the wing deflects radially to the outside, i.e. it is clipped in. The wing itself then assumes the function of a securing element.

The securing element can be inserted in an advantageous manner in the longitudinal direction into the clip element in a manipulation apparatus in accordance with the invention in such a way that the clip element is widened perpendicular to the longitudinal direction. On the one hand, such a pin-like securing element can fix a wing of a clipped connection in the “clipped-in” position, which wing is held in an articulated manner (i.e. load-free) on the manipulation apparatus. On the other hand, the combination with a resilient wing is also useful which in its initial position is deflected radially to the inside, i.e. it is “clipped out”. The clip element is then simultaneously “clipped in” and secured in the holding position only by insertion of the securing element. When the securing element is removed again, the clip element is simultaneously “clipped out” of the holding position and the medical element can be detached from the implant without any resistance.

It has further been proven as being advantageous when the receiving element of a manipulation apparatus in accordance with the invention comprises a projection in an outer jacket surface which faces outwardly perpendicularly to the longitudinal direction and which can be brought into engagement with a respective recess in the inner jacket surface of the receiving recess.

A manipulation apparatus in accordance with the invention which is arranged in this way is connected in an especially secure manner in the longitudinal direction by the interlocking connection with the receiving recess of the medical element. Alternatively, the use of rough surfaces in the corresponding jacket surfaces is useful, so that the manipulation apparatus and the medical element are securely connected in the longitudinal direction by a defined friction-type connection.

Said projection can especially be formed by an elastic securing which is incorporated in the outer jacket surface. Securing rings made of an elastomer material which can also be biocompatible are available on the market in a large variety and at a low price. The manipulation apparatus in accordance with the invention can thus be produced in a very simple and cost-effective manner.

Based on the known medical elements it is proposed in accordance with the invention to provide a receiving recess, into which a receiving element of the manipulation apparatus can be introduced in a longitudinal direction of the receiving recess and in which the receiving element can be secured by means of a securing ring against displacement in the longitudinal direction. The medical element in accordance with the invention allows executing the method in accordance with the invention in combination with a respective manipulation apparatus.

A medical element in accordance with the invention preferably comprises a recess which faces outwardly perpendicularly to the longitudinal direction in an inner jacket surface of the receiving recess, which recess can be brought into engagement with a respective projection in an outer jacket surface of the receiving element. Such a medical element in accordance with the invention can be inserted together with the manipulation apparatus in accordance with the invention as described above with a respective projection in the outer jacket surface.

Based on the known implants, it is proposed in accordance with the invention that the implant is pre-mounted with a medical element, which is a healing cap, with a torque being introducible in the longitudinal direction for screwing in the implant in the receiving recess of the medical element by means of a manipulation apparatus introduced in an interlocking manner. An implant which is thus pre-mounted can be implanted without any direct contact of the actual implant body with a manipulation element and without any risk of damage or surface wear which is usually accompanied with such contact. Moreover, the pre-mounted healing cap offers sufficient guarantee for the unimpaired sterility even of the cavity in the implant body in which the final medical element is to be received after the healing.

### EMBODIMENTS

The invention is now explained in closer detail by reference to embodiments, wherein the figures show in combination with a medical element in accordance with the invention:

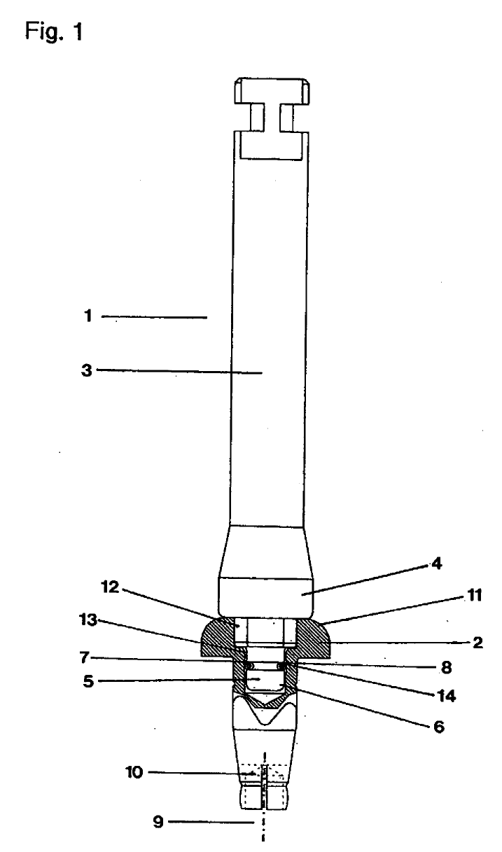

FIG. 1 shows a first;

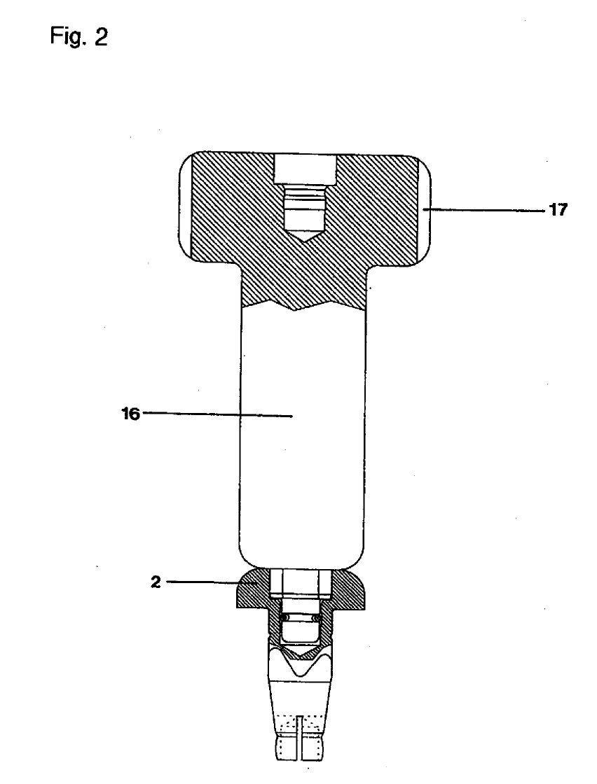

FIG. 2 shows a second, and

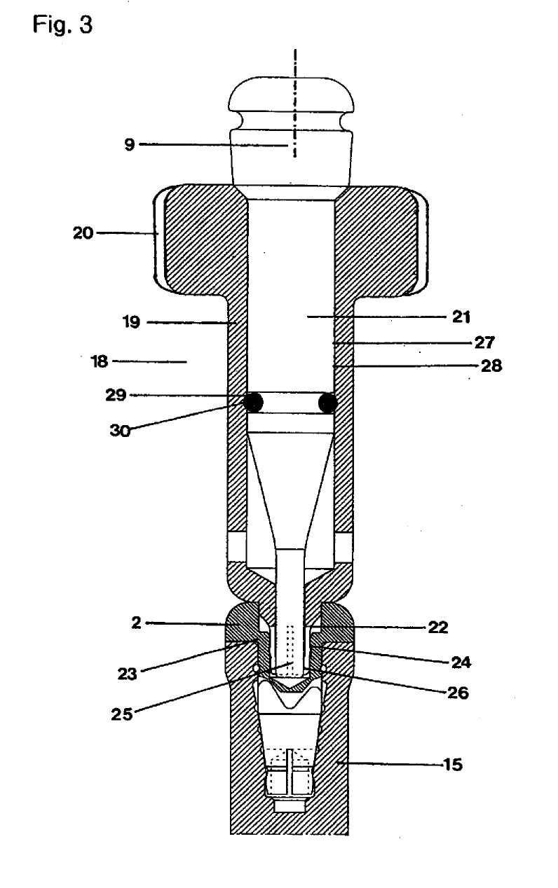

FIG. 3 shows a third manipulation apparatus in accordance with the invention.

The manipulation apparatus 1 in accordance with the invention as shown in FIG. 1 is an insertion tool or “insertion post” for use with a rotatable tool holder (the so-called dentist's drill) which is not shown, is usually driven pneumatically and by means of which a medical element 2, which is a healing cap, can be received.

The manipulation apparatus 1 is made of special steel and has a cylindrical oblong basic body 3 which starts out from a standardized connecting bracket (the so-called “elbow bracket”) and which after a slight bulging section 4 ends in a clearly narrower pin-like receiving element 5 as compared with the basic body 3. The receiving element 5 has a circumferential groove 7 in its jacket 6 with a securing element 8 incorporated therein, which is a retaining ring, and perpendicular to the longitudinal direction 9 a non-rotation-symmetrical profile (not shown), so that a torque can be transmitted in the longitudinal direction 9 via the receiving element 5.

The medical element 2 comprises a clip element 10 and a head area 11 which is enlarged in a cap-like manner, is rounded off to the sides at the top and has a receiving recess 12 which is adjusted to the shape of the receiving element 5 of the manipulation apparatus 1. The receiving recess 12 comprises in its jacket 13 a circumferential, outwardly facing recess 14 which is perpendicular to the longitudinal direction 9.

For implanting an implant 15 which is pre-mounted with the medical element 2 (only shown in FIG. 3) into a receiving bore in a bone (not shown), the receiving element 5 of the manipulation apparatus 1 is introduced into the receiving recess 12 of the medical element 2, where it is secured against inadvertent releasing by latching of the securing element 8 in the recess 14 in the jacket surface 13 of the receiving recess 12. The medical element 2 is connected with the implant 15 via the clip element 10 which is also suitable for transmitting a torque, so that the implant 15 can be screwed into the receiving bore through rotation of the manipulation apparatus 1. The connection of the manipulation apparatus 1 with the medical element 2 is arranged in such a way that the tensile forces which are transmitted here are considerably lower than those that can be transmitted in the connection between the medical element 2 and the implant 15. The manipulation apparatus 1 can be removed from the implant 15 by simple pulling, with the medical element 2 remaining in the same.

The second manipulation apparatus 16 in accordance with the invention as shown in FIG. 2 is an alternative insertion tool, by means of which the medical element 2, which is the healing cap (known from FIG. 1), can be received. In contrast to the first manipulation apparatus 1 in accordance with FIG. 1, the second manipulation apparatus 16 allows a manual implantation of the implant 15 (not shown here) instead of the use of the dentist's drill. Instead of the machine connection bracket, this manipulation apparatus 16 which is also made of special steel comprises for this purpose a clearly enlarged, knurled head 17.

The third manipulation apparatus 18 in accordance with the invention as shown in FIG. 3 is a positioning and withdrawal tool for the medical element 2 or for a gingival former (not shown) in the further course of the implantation. The manipulation apparatus 18 comprises a substantially tubular basic body 19 with an enlarged handle end 20 for manual handling, a securing element 21 which is introduced into the basic body 19 and a receiving element 22 which is arranged relative to the handle end 20 as a clip element.

In the region of the receiving element 22, the outer jacket surface 23 of the manipulation apparatus 18 comprises attached projections 24 perpendicular to the longitudinal direction 9 which face outwardly. The receiving element 22 comprises four tongues 26 which are formed by four incisions 25 in the longitudinal direction 9, of which there may be at least one and up to eight thereof, and preferably four to six, and which tongues are connected with the basic body 19 in an elastic resilient manner. Basic body 19 and the securing element 21 of the manipulation apparatus 18 are made of metal or a biocompatible plastic by means of injection molding. The securing element 21 comprises a circumferential groove 29 in the jacket surface 27 of the first cylindrical section 28, in which a silicone ring 30 is inserted as an anti-slip means.

For removing the medical element 2 from the implant 15 which has healed into the jawbone (not shown), the receiving element 22 of the third manipulation apparatus 18 is introduced into the receiving recess 12 of the medical element 2 and the clip element is spread out by the introduction of the securing element 21. The connection of the manipulation apparatus 18 with the medical element 2 is arranged in such a way that the tensile forces which are transmitted here clearly exceed the ones which can be transmitted in the connection between the medical element 2 and the implant 15. The medical element 2 can be removed simply from the implant 15 by pulling the manipulation apparatus 18.

In a further embodiment with a fourth manipulation apparatus which is not shown separately but corresponds substantially to FIG. 3, its receiving element is introduced into the receiving recess 12 of the medical element 2 in which the pretensioned clip element is spread out automatically and thus will “clip in”. The connection of the fourth manipulation apparatus with the medical element 2 is arranged in such a way that the tensile forces that are transmitted here fall below those which can be transmitted in the connection between the medical element 2 and the implant 15.

After the insertion of the implant 15 which is pre-mounted with the medical element 2, the fourth manipulation apparatus can be removed without any further manipulation from the medical element 2, with the same remaining securely in the implant as a result of the higher holding forces. For removing the medical element 2, the fourth manipulation apparatus is again introduced into the receiving recess 12 of the medical element 2, where it will automatically spread out again. By introducing the securing element 21 into the clip element, the clip element is now blocked in such a way that the tensile forces which are transmitted here will clearly exceed those which can be transmitted in the connection between the medical element 2 and the implant 15. The medical element 2 can be removed again by simply pulling with the fourth manipulation apparatus.

The Figs. show as follows:
1 Manipulation apparatus
2 Medical element
3 Basic body
4 Enlargement
5 Receiving element
6 Jacket surface
7 Groove
8 Clip element
9 Longitudinal direction
10 Clip element
11 Head area
12 Receiving recess
13 Jacket surface
14 Recess
15 Implant
16 Manipulation apparatus
17 Head
18 Manipulation apparatus
19 Basic body
20 Handle end
21 Securing element
22 Receiving element
23 Jacket surface
24 Projection
25 Incision
26 Tongue
27 Jacket surface
28 Cylindrical section
29 Groove
30 Silicone ring

1. A method for receiving a medical element (2) in a manipulation apparatus (1, 16, 18), with the medical element (2) being received by means of a receiving element (5, 22) in such a way that it can be inserted in an implant (15) by means of a manipulation apparatus (1, 16, 18) having the receiving element (5, 22) or can be removed from the implant, with the receiving element (5, 22) being introduced into the receiving recess (12) in a longitudinal direction (9) of a receiving recess (12) of the medical element (2) and being secured in the receiving recess (12) by means of a clip element against displacement in the longitudinal direction (9), characterized in that a securing element (21) is introduced in the longitudinal direction (9) into the clip element in such a way that the clip element is spread open and/or blocked perpendicular to the longitudinal direction (9).

2. A manipulation apparatus (1, 16, 18) for a medical element (2), comprising a receiving element (5, 22) by means of which the medical element (2) can be received for insertion into an implant (15) or for removal from the implant (15), with the receiving element (5, 22) being introducible into a receiving recess (12) of the medical element (2) in a longitudinal direction (9) of the receiving recess (12) and being securable by means of a clip element against displacement in the longitudinal direction (9), characterized in that securing element (21) can be introduced in the longitudinal direction (9) into the clip element in such a way that the clip element is spread open and/or blocked perpendicular to the longitudinal direction (9).

3. A manipulation apparatus (18) according to claim 2, characterized by a clip element arranged on the receiving element (22), comprising at least one wing which is movable transversally to the longitudinal direction (9) and which can be brought into engagement in a non-positive manner with an inner jacket surface (13) of the receiving recess (12).

4. A manipulation apparatus (18) according to claim 3, characterized in that the wing is connected in a resilient manner with the receiving element (22).

5. A manipulation apparatus (1, 16, 18) according to claim 2, characterized in that the receiving element (5, 22) comprises in an outer jacket surface (6) a projection (24) which faces outwardly perpendicular to the longitudinal direction (9) and which can be brought into engagement with a respective recess (14) in the inner jacket surface (13) of the receiving recess (12).

6. A manipulation apparatus (1, 16) according to claim 5, characterized in that the projection (24) is formed by an elastic securing ring incorporated in the outer jacket surface (6).

7. An implant (15) which can be implanted in a bone by screwing into a receiving bore, characterized in that the implant (15) is pre-mounted with a medical element (2), which is a healing cap, with a torque being introducible for screwing in the implant (15) in a receiving recess (12) of the medical element (2) in accordance with claim 2 by means of a manipulation apparatus (1, 16, 18) introduced in an interlocking manner.
